(19) United States
(12) Patent Application Publication
(10) Pub. No.: US 2025/0125838 A1
(43) Pub. Date: Apr. 17, 2025

(54) SYSTEMS AND METHODS FOR UE COOPERATIVE MIMO

(71) Applicant: Huawel Technologies Co., Ltd., Shenzhen (CN)

(72) Inventors: Hua Xu, Ottawa (CA); Jianglei Ma, Ottawa (CA)

(21) Appl. No.: 18/980,936

(22) Filed: Dec. 13, 2024

Related U.S. Application Data
(63) Continuation of application No. PCT/CN2023/085453, filed on Mar. 31, 2023.
(60) Provisional application No. 63/352,299, filed on Jun. 15, 2022.

(51) Int. Cl. H04B 7/0413; H04L 1/1867

(52) U.S. Cl. CPC H04B 7/0413; H04L 1/1896

(57) ABSTRACT

A transmitter and receiver framework that is flexibly configurable between various cooperative MIMO configurations is provided, for example, between closed-loop MIMO and open-loop MIMO. A method of signaling is provided for use in configuring a shared medium access control (MAC) layer in a first apparatus, such as a user equipment, for use in cooperative transmission by a plurality of apparatus inclusive of the first apparatus.

### CROSS-REFERENCE TO RELATED APPLICATIONS

This application is a continuation application of international application No. PCT/CN2023/085453, filed on Mar. 31, 2023, titled “SYSTEMS AND METHODS FOR UE COOPERATIVE MIMO”, which claims priority to United States Provisional Patent Application Ser. No. 63,352,299, titled “SYSTEMS AND METHODS FOR UE COOPERATIVE MIMO”, filed Jun. 15, 2022, both of which are incorporated herein by reference in their entireties.

### TECHNICAL FIELD

The application relates to wireless communications generally, and more specifically to systems and methods for user equipment (UE) cooperative multiple input multiple output (MIMO) communications.

### BACKGROUND

In a conventional wireless communication system, each user equipment (UE) transmits/receives to/from a base station by itself. Such a system can be viewed as a cell-centric system. UE-to-UE communication, also referred to as device to device or D2D, has been studied and specified in order to improve direct communication between UE. In contrast to UE-to-UE communication, UE cooperation (UC) involves a group of UE working together to improve transmission/reception to/from the base station as well as between UE(s). A system featuring UE cooperation can be viewed as a UE-centric system. Such a system may be used to complement the conventional cell-centric system and to improve the overall system performance and capacity.

UC multiple input multiple output (MIMO) involves the use of antennas and transmit power of multiple UE to transmit/receive data together and thus benefit from the improved transmit power/spatial diversity/multiplexing. However, UC MIMO requires more precise phase alignment/synchronization among UE(s), which may be hard to achieve. For example, UC coherent joint transmission (CJT) MIMO would require UE(s) to frequently have stringent phase alignment among UE(s) in order to obtain the benefits, which may put more requirements on the UE(s) and system.

### SUMMARY

A transmitter and receiver framework that is flexibly configurable between various cooperative MIMO configurations is provided, for example, between closed-loop MIMO and open-loop MIMO. A method of signaling is provided for use in configuring a common medium access control (MAC) layer in a first apparatus, such as a user equipment, or an apparatus in a user equipment, for use in cooperative transmission by a plurality of apparatus inclusive of the first apparatus. A closed-loop MIMO configuration and open-loop MIMO configuration (more generally different MIMO configurations) are each most effective in different contexts or network conditions; a flexible framework may be used to allow switching between different configurations to achieve a configuration suitable for given context or network condition.

According to one aspect of the present disclosure, there is provided a method in a first apparatus comprising: receiving configuration of a common medium access control (MAC) entity in the first apparatus for use in cooperative transmission by a plurality of apparatus inclusive of the first apparatus; transmitting a transport block (TB) of data to a network device as part of the cooperative transmission; and communicating a TB of data to another apparatus of the plurality of apparatus for transmission to the network device by the another apparatus as part of the cooperative transmission.

In some embodiments, the common MAC entity comprises a common HARQ entity or a plurality of HARQ entities.

In some embodiments, the common MAC entity comprises a common HARQ entity configured with one or more HARQ processes each of which is associated with one or more of the plurality of apparatus.

In some embodiments, said transmitting a TB of data to a network device and said communicating a TB of data to another apparatus both involve a same TB of data; the common MAC entity comprises a common HARQ entity, and wherein the common HARQ entity is configured with a HARQ process for managing the transmission of the same TB of data by the first apparatus and the another apparatus.

In some embodiments, said transmitting a TB of data to a network device and said communicating a TB of data to another apparatus of the plurality of apparatus both involve a same TB of data; the common MAC entity comprises a first HARQ entity that is configured with a first HARQ process for managing the said transmitting a TB of data to a network device and a second HARQ entity that is configured with a second HARQ process for managing the transmission of the same TB of data by the another apparatus.

In some embodiments, the common MAC entity comprises a first HARQ entity that is configured with a first HARQ process for managing transmission of a first TB of data by the first apparatus and a second HARQ entity that is configured with a second HARQ process for managing transmission of a second TB of data by the another apparatus.

In some embodiments, the common MAC entity comprises a first HARQ entity in respect of TB transmission by the first apparatus and another HARQ entity in respect of TB transmission by the another apparatus of the plurality of apparatus, wherein: in a case of duplicate TB transmission, the first HARQ entity is configured with a first HARQ process in respect managing said transmitting a TB of data to the network device by the first apparatus and the second HARQ entity is configured with another HARQ process in respect of managing duplicate transmission of the same TB of data by the another apparatus; in a case of split TB transmission, the first HARQ entity is configured with a first HARQ process in respect of said transmitting a TB of data to the network device by the first apparatus, and the second HARQ entity is configured with a second HARQ process in respect of transmission of a second TB of data by the another apparatus.

In some embodiments, the common MAC entity supports output of duplicated TBs and split TBs to the PHY layers of the plurality of apparatus, the method further comprising: in a case the MAC entity outputs duplicated TBs, said communicating a TB of data to the another apparatus comprises communicating a same TB of data as the TB of data transmitted by the first apparatus to the network device; in a case the MAC entity outputs split TBs, said communicating a TB of data to the another apparatus comprises communicating a different TB of data than the TB of data transmitted by the first apparatus to the network device.

In some embodiments, the configuration configures whether to use open-loop MIMO or closed-loop MIMO for the cooperative transmission.

In some embodiments, in a case where the first apparatus is configured to use closed-loop MIMO, the configuration further indicating between using a precoder indicated from the network, and using a precoder based on measurement of a downlink reference signal.

In some embodiments, in a case where the first apparatus is configured to use closed-loop MIMO, the configuration further indicating whether coherent or non-coherent precoding is to be used.

In some embodiments, the method further comprises: receiving a downlink control information (DCI) that schedules transmission by the first apparatus or that schedules transmission by the first apparatus and the another apparatus; in a case where the DCI schedules transmission by the first apparatus and the another apparatus, conveying signaling information to the another apparatus that schedules transmission by the another apparatus.

In some embodiments, the DCI comprises: an explicit or implicit indication of whether the DCI schedules transmission by the first apparatus or by the first apparatus and by the another apparatus.

According to another aspect of the present disclosure, there is provided a method in a network device comprising: transmitting to a first apparatus a configuration of a common medium access control (MAC) entity in the first apparatus for use in cooperative transmission by a plurality of apparatus inclusive of the first apparatus; receiving a transport block (TB) of data from the first apparatus as part of the cooperative transmission; receiving a TB of data from another apparatus of the plurality of apparatus as part of the cooperative transmission.

In some embodiments, the common MAC entity comprises a common HARQ entity or a plurality of HARQ entities.

In some embodiments, the common MAC entity comprises a common HARQ entity configured with one or more HARQ processes each of which is associated with one or more of the plurality of apparatus.

In some embodiments, receiving a TB of data from the first apparatus and said receiving a TB of data from another apparatus both involve a same TB of data; the common MAC entity comprises a common HARQ entity, and wherein the TB of data received from the first apparatus and the same TB of data received from the another apparatus are managed by the same HARQ process configured for the common HARQ entity.

In some embodiments, said receiving a TB of data from the first apparatus and said receiving a TB of data from another apparatus of the plurality of apparatus both involve a same TB; the common MAC entity comprises a first HARQ entity and a second HARQ entity wherein the TB of data received from the first apparatus is managed by a first HARQ process configured for the first HARQ entity and the same TB of data received from the another apparatus is managed by a second HARQ process configured for the second HARQ entity.

In some embodiments, the common MAC entity comprises a first HARQ entity that is configured with a first HARQ process for managing transmission of a first TB of data by the first apparatus and a second HARQ entity that is configured with a second HARQ process for managing transmission of a second TB of data by the another apparatus.

In some embodiments, the common MAC entity comprises a first HARQ entity in respect of TB transmission by the first apparatus and another HARQ entity in respect of TB transmission by the another apparatus of the plurality of apparatus, wherein: in a case of duplicate TB transmission, the first HARQ entity is configured with a first HARQ process in respect managing said transmitting a TB of data to the network device by the first apparatus and the second HARQ entity is configured with another HARQ process in respect of managing duplicate transmission of the same TB of data by the another apparatus; in a case of split TB transmission, the first HARQ entity is configured with a first HARQ process in respect of managing said transmitting a TB of data to the network device by the first apparatus, and the second HARQ entity is configured with a second HARQ process in respect of managing transmission of a second TB of data by the another apparatus.

In some embodiments, the configuration configures whether to use open-loop MIMO or closed-loop MIMO for the cooperative transmission.

In some embodiments, in a case where the first apparatus is configured to use closed-loop MIMO, the configuration further indicating between using a precoder indicated from the network, and using a precoder based on measurement of a downlink reference signal.

In some embodiments, in a case where the first apparatus is configured to use closed-loop MIMO, the configuration further indicating whether coherent or non-coherent precoding is to be used.

In some embodiments, the method further comprises: transmitting a downlink control information (DCI) that schedules transmission by the first apparatus or that schedules transmission by the first apparatus and the another apparatus.

In some embodiments, the DCI comprises: an explicit or implicit indication of whether the DCI schedules transmission by the first apparatus or by the first apparatus and by the another apparatus.

According to another aspect of the present disclosure, there is provided an apparatus comprising: a processor and memory, the apparatus configured to execute the method of as described herein.

According to another aspect of the present disclosure, there is provided a network device comprising: a processor and memory, the apparatus configured to execute the method as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIGS. 5A and 5B show framework configurations for close-loop MIMO;

FIGS. 6A and 6B show framework configurations for open-loop MIMO;

FIG. 7 shows an example of signaling channels to switch between different UC MIMO configurations;

FIGS. 8A, 8B and 8C show details of a common medium access control (MAC) entity with a single HARQ entity, association between joint HARQ processes and corresponding physical shared channel of participating UE(s), and multiple HARQ entities, for uplink transmission; and

FIGS. 9A and 9B show details of a common MAC entity with a single HARQ entity, and multiple HARQ entities respectively, for downlink transmission.

### DETAILED DESCRIPTION OF ILLUSTRATIVE EMBODIMENTS

UC MIMO could be used to provide benefits of improved transmit power/spatial diversity/multiplexing. However, this may come with requirements for precise alignment and synchronization among UE(s), which may be hard to achieve. A transmitter and receiver framework that is flexibly configurable between various cooperative MIMO configurations is provided, for example, between closed-loop MIMO and open-loop MIMO.

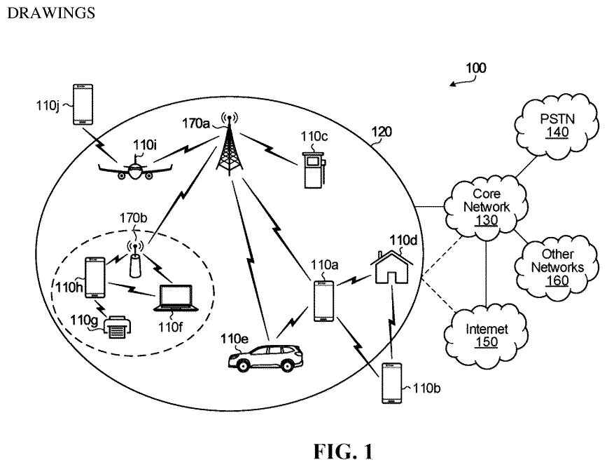

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network130 may be a part of the communication system and may be dependent or independent of the radio access technology used in the communication system 100. Also the communication system 100 comprises a public switched telephone network (PSTN) 140, the internet 150, and other networks 160.

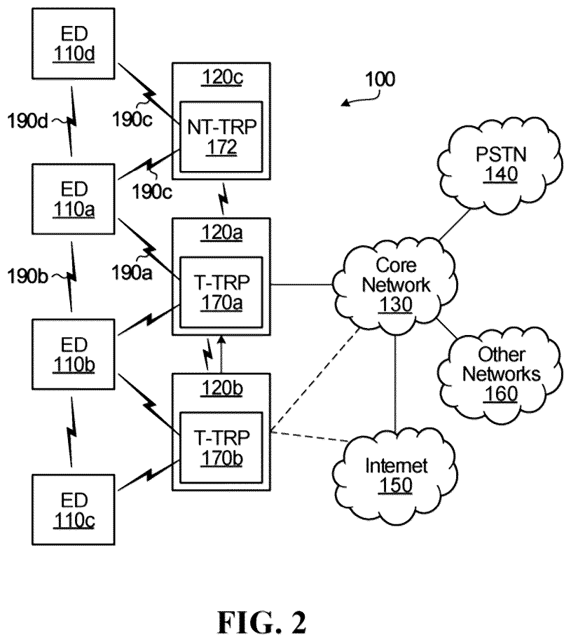

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

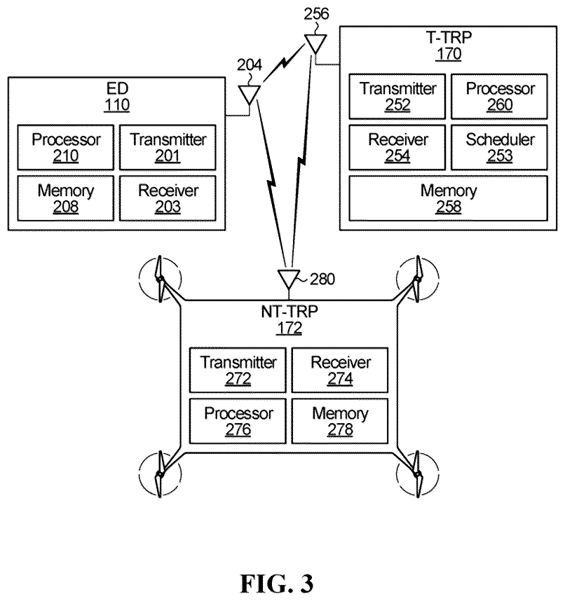

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a terminal device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

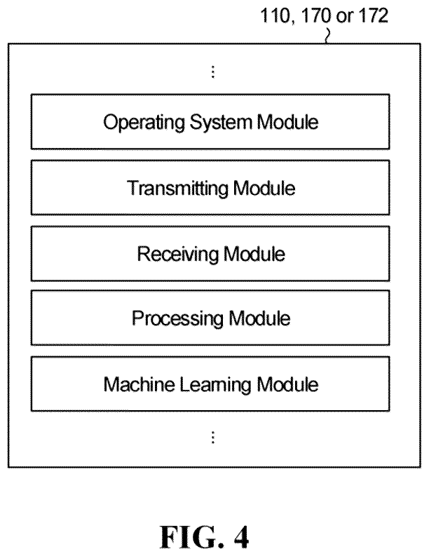

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Closed-Loop and Open-Loop UC MIMO

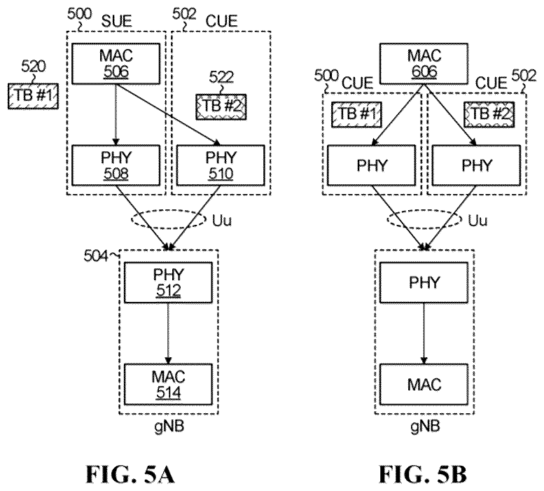

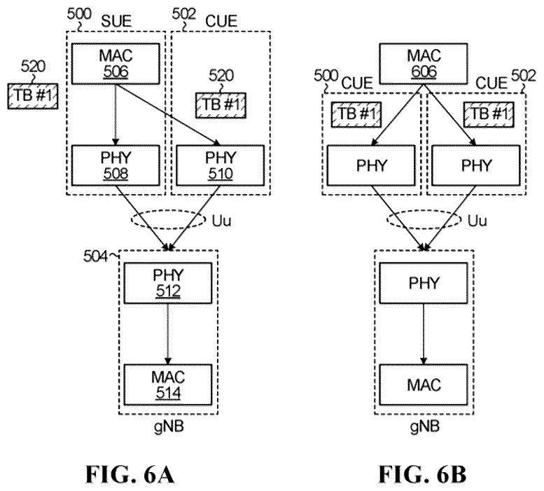

A transmitter and receiver framework that is flexibly configurable between various cooperative MIMO schemes is provided, for example, between closed-loop MIMO and open-loop MIMO. Transmitters and receivers configured to implement this framework may, for example, be in accordance with one or more of the examples of FIGS. 1 to 4. The framework is shown in a close-loop MIMO scheme in FIG. 5A, and in an open-loop MIMO scheme in FIG. 6A.

First, the components of the framework will be described with reference to FIG. 5A. Then, the specific configuration for closed-loop MIMO and open-loop MIMO will be described.

Shown is a first UE 500 functioning as a source UE (SUE) and a second UE functioning as a cooperating UE (CUE). A SUE is referred to as such as it is the source of packets for transmission in this scheme. A CUE is referred to as such, as it is helping the SUE with the transmission. However, more generally, a given UE may be configured as a source UE or a cooperating UE. Also shown is a base station in the form of gNB 504. In FIG. 5A, a common medium access control (MAC) layer 506 (common to SUE 500 and CUE 502) is configured in the SUE (or primary UE, master UE). The two UEs 500,502 each has a respective physical (PHY) layer 508,510. Cooperative transmission is being performed to transmit data of the SUE 500 to the gNB 504 which has its own PHY layer 512 and MAC entity 514, or to receive data of the SUE 500 from the gNB 504 and transmit the received data to the SUE 500.

Various configuration options are available with the framework of FIG. 5A. In some implementations, all of the configuration options are available. Alternatively, a subset of the configuration options may be available. The following is a non-limiting list of four configuration options:

Location of common MAC entity: a common MAC entity for UE cooperation (UC) MIMO transmission or simply UC transmission can be configured on the SUE, and the CUE is not configured with a common MAC entity for UC MIMO transmission. Each UE acts as a SUE in which case it has a common MAC entity configured for a cooperative MIMO transmission, or as a CUE in which case it is not configured with a common MAC entity for the cooperative MIMO transmission. In general, herein, a common MAC entity refers to a MAC entity that acts as the MAC layer for data transmission/reception via plurality of UE(s) in UE cooperation. In some embodiments, the common MAC entity for UC MIMO may be configured external to the two UEs (for example in another UE) in which case both UEs act as CUEs. The common MAC entity is described in further detail below. In some embodiments, signaling is used to configure a common MAC) entity in a UE (more generally a first apparatus) that is to act as a source UE, for use in cooperative transmission by a plurality of UE (more generally a plurality of apparatus) inclusive of the first UE. In another embodiment, the common MAC entity is configured together with the local MAC entity in a SUE, namely, one MAC entity is configured in the SUE with some functions supporting UC MIMO transmission involving both SUE and CUE(s) while some functions that support non-UC transmission involving the SUE only.

Duplicate Transport Blocks (TBs) vs. Split TBs: it is configurable whether TB's output by the MAC entity 506 are duplicated such that the same TBs are dispatched to both PHY layers 508,510, or the TB's output by the common MAC entity 506 are split such that different TBs are dispatched to both PHY layers 508,510. In some embodiments, such configuration is part of a hybrid automatic repeat request (HARQ) configuration as will be described later. It should be mention that transport block (TB) is just an example of a block used to carry the data for the convenience of description. Other format of block used to carry data could also be applied to this application. For simplicity, a TB could be used to describe a TB of data in this application. It should also be mention that although uplink data transmission is described in the description, downlink data transmission is also applicable, e.g., in downlink data transmission, the both PHY layers 508,510 receive the same TBs and delivered them to the common MAC entity 506.

Open-loop MIMO vs. closed-loop MIMO: it is configurable whether to implement open-loop MIMO vs. closed-loop MIMO. With closed-loop UC MIMO, each UE uses a precoding vector based on feedback from the network (e.g. from a base station/gNB). A precoding operation takes place in the PHY layers 508,510. This can involve the transmission of a reference signal by the UE in the uplink, and the receipt of feedback from the base station based on channel measurement from the reference signal indicating what precoder to use. This is also referred to as codebook based (CB) precoding. Alternatively, where a reciprocal channel assumption can be applied, the network may transmit a downlink reference signal, and the UE can derive a precoder to use based on measurements taken on downlink reference signal. This is also referred to as non-codebook based (NCB) precoding. Both approaches are considered closed-loop as they reply on channel measurement for generating precoding vectors. In some embodiments, both the CB based and NCB methods are available/supported and which one to use is configurable. On the other hand, with open loop MIMO, channel-based precoding (based on feedback or downlink channel measurement) is not employed. A benefit of this approach relative to closed-loop MIMO is reduced latency. In addition, with closed-loop MIMO, the channel may change very fast in a closed-loop MIMO system, particularly where the UE is moving quickly, and as such, the channel measurement can become out of date quickly and correspondingly the precoding can also become out of date quickly. As such, closed-loop MIMO is not ideal if the UE is moving quickly but may be suitable for UEs that are slow moving, and therefore have a slowly changing channel. Configuration as between close-loop MIMO and open-loop MIMO can involve configuration of how precoding is performed in each of the PHY layers 508,510, for example as between the following options:
a) based on feedback from the network (closed-loop);
b) based on reciprocal channel measurements taken on downlink reference signals (closed-loop);
c) whether coherent or non-coherent precoding is used: where closed-loop MIMO is employed, the UE may employ coherent joint transmission (CJT) MIMO. In this case, coherent joint precoding is used to apply joint precoding across SUE/CUE(s), for example the joint precoding operation is applied to generate streams for transmissions across all antennas of SUE/CUE together. For example, if each SUE and CUE has two transmit antennas, one joint precoding would be performed to generate four streams to be transmitted across all four antennas of SUE/CUE together. In this case, the same TB of data (or the same TB for simplicity) will be dispatched to SUE/CUE(s) for joint precoding and transmission under the same HARQ process. Alternatively, non-coherent precoding may be used in which case each PHY layer 508,510 performs separate precoding, which means a separate precoding operation is applied to generate streams for transmission across antennas of each SUE/CUE respectively. For example, if each SUE and CUE has two transmit antennas, two separate precoding operations would be performed to generate two separate sets of streams, each to be transmitted over two antennas of the SUE or the CUE respectively;
d) selected by the transmitter without reference to channel measurement (open-loop). In this case, the transmitter may select the precoding vector, which would be configured or pre-defined to apply in the precoding operation. For open-loop MIMO, such precoding vector is not based on uplink (UL) or downlink (DL) channel measurement. HARQ entity: Generally, a HARQ entity is a function that manages one or more HARQ processes. In some embodiments, the HARQ entity is configured in the MAC entity or defined in a MAC entity, one for each cell in a cell group with multiple cells. A respective HARQ process is used to manage the original transmission and re-transmission of one TB. In conventional systems, a HARQ process is configured in the MAC entity of one UE (conventional MAC entity, not common MAC entity), and that HARQ process manages the transmission of a TB of data (or a TB for simplicity) via the PHY layer of that one UE. For UC MIMO, a common HARQ entity can be defined/configured in the common MAC that is responsible for managing the single HARQ process in respect of a jointly or separately precoded TB of data or respective HARQ processes in the case of separately precoded TBs. For example, with separate precoding UC MIMO, TB #1 and TB #2 can be dispatched and transmitted from SUE 500 to the gNB 504 via SUE 500 and CUE 502 respectively as depicted in FIG. 5A. They are transmitted/re-transmitted under HARQ process #1 and #2 respectively. Where the same TB is transmitted from both SUE 500 and CUE 502, either with separate precoding, or joint precoding, the same HARQ process could be used to manage such transmission of the same TB via the SUE and CUE as well. For example, a same TB #1 could be transmitted from the SUE 500 and CUE 502 under the same HARQ process #1.

A first closed-loop MIMO scheme is shown in FIG. 5A. In this scheme, TB splitting is used in which data is split in the common MAC entity into different TBs at the output by the MAC entity to the PHY layers. With this scheme, different TBs are dispatched from the common MAC entity to PHY layers 508,510 of the SUE 500 and CUE 502. In FIG. 5A, TB #1 520 is shown dispatched to PHY 508, and TB #2 522 is shown dispatched to PHY 510. The TBs are then transmitted to the gNB 504 via PHY layers of SUE 508, and CUE 510 respectively. In the example of FIG. 5A, the PHY layers 508,510 are configured to use a precoding vector based on channel measurement (for example from feedback from gNB or reciprocal channel measurement, close-loop MIMO), and non-coherent UC MIMO, meaning that each UE performs precoding separately in its respective PHY layer. Different precoders are used to precode a first TB at the SUE and a second TB at the CUE for transmission under separate HARQ processes. For the example of FIG. 5A, signaling is used to configure the common MAC entity in SUE 500.

A second closed-loop MIMO scheme is shown in FIG. 5B. In this scheme, a common MAC entity 606 is configured situated external to both UE 500,502 (for example in another UE or another device, not shown), and as such neither UE 550,502 has a configured common MAC entity for UC MIMO and each can be viewed as a CUE. The rest of the scheme and data flow is the same as FIG. 5A. A CUE may still have its own MAC entity for its own transmission, but not for UC MIMO, as the common MAC entity is used for UC MIMO.

While FIGS. 5A and 5B show a closed-loop MIMO scheme with TB splitting, a close-loop MIMO scheme can also be used for TB duplication. In this case, the same TB is duplicated and dispatched from the common MAC entity to the PHY layers of SUE 500 and CUE 502 respectively. Separate precoding is then performed on the same TB in PHY layers of each SUE 500 and CUE 502 respectively for transmission to the gNB 504.

A first example of open-loop MIMO scheme is shown in FIG. 6A. In this example, UE 500 is configured with common MAC entity 506 to function as SUE, and UE 502 is configured as CUE. The MAC entity 506 is configured to duplicate TBs for transmission by both UEs. The PHY layers 508,510 are configured with open loop MIMO transmission. For example, each PHY layer 508,510 uses a respective cyclic precoder for precoding the same TB. A joint HARQ process is used across SUE/CUE for the same TB. For example, as shown in FIG. 6A, TB #1 is dispatched and transmitted from SUE 500 and CUE 502 to the gNB 504 respectively using respective cyclic precoders. TB #1 is transmitted/re-transmitted under the same HARQ process #1 for example.

A second open-loop MIMO scheme is shown in FIG. 6B. In this scheme, a common MAC entity 606 is configured situated external to both UE 500,502 (for example in another UE, not shown), and as such neither UE 500,502 has a configured common MAC entity for UC MIMO and each UE can be viewed as a CUE. The rest of the scheme and data flow is the same as FIG. 6A.

In some embodiments, each of the four configuration options is separately configurable, for example based on signaling from the network, which leads to the most flexibility. More generally, there may be a different set of configuration options than those specifically listed, each of which is separately configurable.

Alternatively, a set of transmitter configurations are defined; each defined transmitter configurations includes a specific configuration for each of the options (more generally for each of some set of configuration options). For example, there could be one or more defined transmitter configurations for closed-loop MIMO, and one or more defined transmitter configurations for open-loop MIMO. The defined transmitter configurations may be predefined, or configured.

In some embodiments, the network (for example a gNB) controls which configuration is active, for example switching between a close-loop configuration and an open-loop configuration. Various factors may be considered in deciding when to switch. For example, the switch decision could be made by the gNB depending on success/failure rate of the data transmission under each configuration. For example, if closed-loop MIMO is used and at some point, an increase in the number of decoding failures is observed, this could imply strong inter-UE interference (more correlated mutual channels between UEs participating in UC MIMO transmission) or higher mobility (thus the closed-loop MIMO may not perform well due to latency). The gNB could switch the UE to an open-loop MIMO configuration.

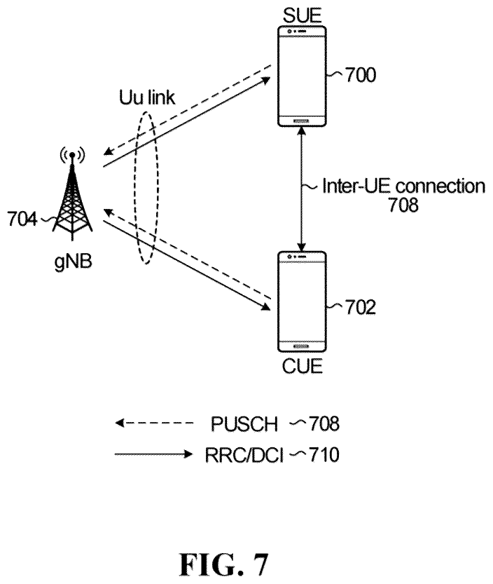

In some embodiments, higher layer signaling such as radio resource control (RRC) signaling is used to indicate which configuration to use. Alternatively, dynamic signaling can be used to indicate which configuration to use; for example, an implicit or explicit indication in a DCI can be used to indicate the configuration. FIG. 7 shows an example of the signaling links that might be employed. FIG. 7 shows UE 700 functioning as an SUE, UE 702 functioning as a CUE and a gNB 704. Also shown is a connection 708 between the two UE 700,702. For this and other embodiments, the inter-UE connection 704 may, for example, be a 3GPP specified connection (e.g., sidelink or PC5 link) or non-3GPP specified connection (e.g., WiFi, Bluetooth, Ethernet etc) or a non-standardized connection. It is used to covey data and control between UEs participating in UC MIMO. For example, in UC MIMO, when TBs are dispatched from the common MAC entity (in this example, it is assumed to be configured in SUE 700), they would be conveyed to the CUE 702 via the inter-UE connection 708. The PHY layer of CUE 702 would then process (performing channel coding, modulation, precoding etc) and transmit them to gNB 704. The same or different TBs could be passed from the common MAC entity situated in SUE 700 to the PHY layer of CUE 702 and be processed (performing channel coding, modulation, precoding etc) before being transmitted to the gNB 704. Generally indicated at 710 are downlink control signaling possibilities in the form of RRC or downlink control information (DCI) which can be used to set/control the configuration of the UE. Also shown at 710 are uplink physical uplink shared channel (PUSCH) transmissions, which are the uplink transmissions to transmit the data packets from the UEs to the gNB using UC MIMO.

In some embodiments, presence/absence of valid precoding information in a DCI is used to implicitly indicate whether closed-loop MIMO vs. open-loop MIMO is to be employed. For example, a DCI can be used to convey a valid or an invalid precoding information (e.g., precoder vector/matrix indices), with a valid precoding information indicating to the UE to apply a closed-loop precoding operation accordingly using the indicated valid precoder, and an invalid precoding information indicating to the UE to apply a cyclic precoding operation for open-loop MIMO using pre-defined/pre-configured cyclic precoders. Alternatively, an explicit indication could be contained in a DCI to indicate closed-loop MIMO (mode) or open-loop MIMO (mode). For example, a 1-bit indication can be used to directly indicate one of closed-loop MIMO and open-loop MIMO for the UC MIMO transmission. Alternatively, a 1-bit indication can be used indicate a switch between closed-loop MIMO and open-loop MIMO (e.g, when this bit is toggled between two consecutive DCI, switch from the current UC MIMO transmission mode (either open-loop MIMO or closed-loop MIMO) to the other UC MIMO mode). In some embodiments, the selection/switching between open-loop MIMO and closed-loop MIMO is indicated by a MAC entity signaling such as MAC control element (MAC CE).

The provided framework provides more flexible MIMO transmission for UC. Closed-loop UC MIMO can be used to improve UE and system throughput, while open-loop UC MIMO can be used to improve diversity and robustness, which could be beneficial for the cell edge UEs or UEs with relatively higher mobility.

### Common Mac/Harq Structure and Procedure for UC MIMO

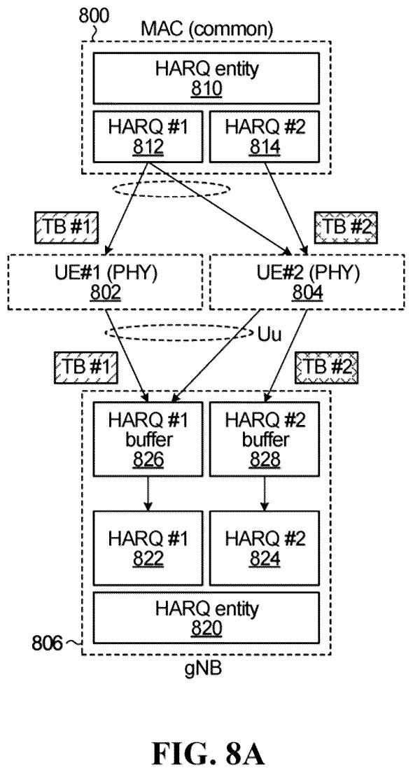

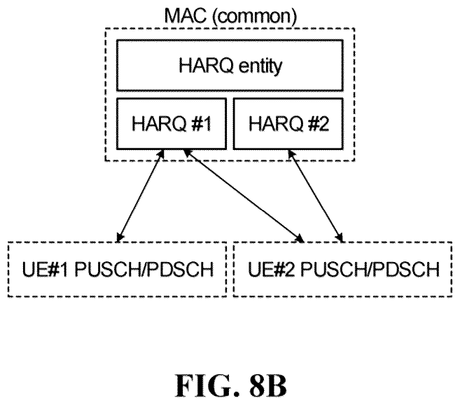

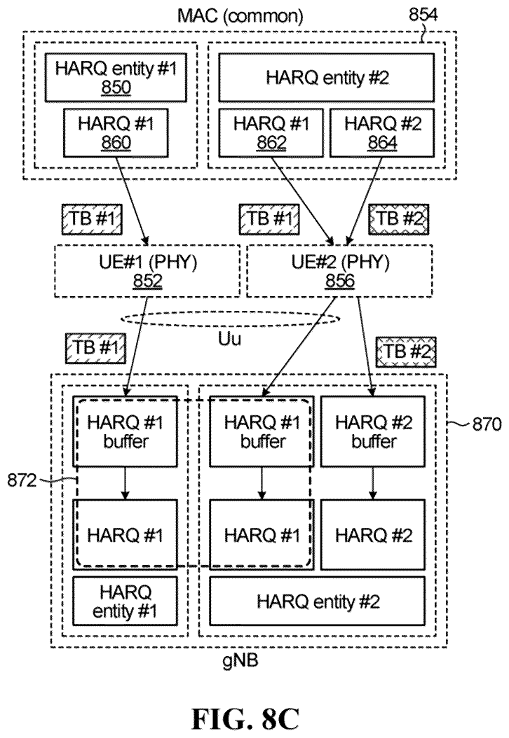

Further details of a common MAC entity for uplink UC MIMO will be described with reference to FIG. 8A. Shown is a common MAC entity 800, PHY layers of two UE 802,804 respectively and a gNB 806. The common MAC entity 800 could be configured in one of the UE containing UE PHY layer 802 or 804 (in which case that UE can be viewed as a master UE/primary UE/SUE) or in another device, such as another UE. The connections between the common MAC entity 800 and individual UE PHY layer could be wireless or wireline connection, and could be either standardized (e.g., 3GPP, IEEE) or non-standardized. The common MAC entity 800 has a common HARQ entity 810 configured that manages a number of HARQ processes. In some embodiments, the number of HARQ processes managed by the common HARQ entity 810 is configurable. FIG. 8A shows two HARQ processes 812, 814. In the gNB 806, there is a corresponding HARQ entity 820 configured with corresponding HARQ processes 822,824 as shown in the gNB along with corresponding HARQ buffers 826,828 for storing/decoding received data managed under each HARQ process. It should be mentioned that a TB is not actually dispatched from HARQ process 812 to the PHY layer of a UE for its (re-) transmission. The HARQ process is more a function managing the (re-) transmission of the TB. The similar aspect is applied to the receiver side where a HARQ process does not actually processed a received TB of data itself, but rather manages the (re-) transmission of the TB by informing the success/failure of the decoding of the data.

The common HARQ entity supports joint HARQ processes. In this case, uplink data (e.g., TB) (re-) transmission (transmissions and re-transmissions of the same TB) under a given HARQ process can be scheduled to be transmitted from different UE(s). The same or different redundancy version (RV) of the same TB can be scheduled from different UE(s). An example is shown in FIG. 8A, where transmission (or retransmission) of TB #1 under joint HARQ process #1 is scheduled to be transmitted from UE #1 and UE #2 respectively. RV #0 of TB #1 could be scheduled from UE #1 and RV #2 of TB #1 could be scheduled from UE #2.

The joint HARQ process can be referred as a split HARQ process as well meaning the HARQ process is split across different UEs to manage the transmission/reception of the same TB. The joint HARQ process (or split HARQ process) could be configured to associate with different physical shared channels operating on different UEs, through which, the corresponding (re-) transmission of the TB are carried out for example, the physical uplink shared channel (PUSCH) or physical downlink shared channel (PDSCH). For example, joint HARQ process #1 could be configured to associate with PUSCH or PDSCH channels on UE #1 and UE #2 respectively. FIG. 8B shows an example of such association between HARQ process and channel. For example, HARQ process #1 is associated with corresponding physical shared channels (e.g., PUSCH and PDSCH) used to transit/receive the data by UE #1 and UE #2 respectively while HARQ process #2 is associated with corresponding physical shared channels (e.g., PUSCH and PDSCH) used to transit/receive the data by UE #2, With such an association configured, both UE(s) and gNB could know that TB(s) managed under a certain HARQ process are to be transmitted using corresponding physical shared channels such as PUSCH via corresponding UE(s) participating in UC MIMO. Alternatively, the joint HARQ process can be configured to associate with a number of corresponding UE(s) through which the (re-) transmission of the TB it manages are carried out.

In some embodiments, the common HARQ entity also supports individual HARQ processes (similar as conventional HARQ process). In this case UL data (e.g., TB) (re-) transmission for a TB is only scheduled from one UE. An example is shown in FIG. 8A, where transmission (or retransmission) of TB #2 under individual HARQ process #2 is scheduled from UE #2 only. Note that the common HARQ entity managing an individual HARQ process can be located elsewhere than in the UE making the transmission. For example, the HARQ entity could be located in one UE while the TB transmission/reception it manages could be conducted in the PHY layer of another UE. In this case, the association between the HARQ process and physical shared channel such as PUSCH on PHY layer of that particular UE is configurable. For example, HARQ process #2 can be configured to be associated with physical shared channels of UE #2.

Either or both of joint HARQ processes and individual HARQ processes could be configured for the UE(s). For example, HARQ process #1 could be configured as a joint (split) HARQ process while HARQ process #2 could be configured as an individual HARQ process. The configuration including association between HARQ process and correspond physical shared channels of participated UE(s) could be signaled to corresponding UE(s), for example. UE #1 and UE #2 respectively.

With the above configuration, during transmission, the gNB could use scheduling to schedule (re-) transmissions managed by both types of HARQ process and combine them at gNB accordingly.

Alternatively, for UL UC transmission, in some embodiments, two or more HARQ entities are configured in the common MAC entity, one for each UE involved in UC transmission. An example is shown in FIG. 8C which shows HARQ entity #1 850 configured for UE #1 852 and HARQ entity #2 854 configured for UE #2 856. For HARQ entity #1 850, it supports HARQ process #1 860 to transmit TB #1 via UE #1 852 to the gNB 870. For HARQ entity #2 854, it supports HARQ process #1 862 to transmit TB #1 via UE #2 856 to the gNB 870. It also supports HARQ process #2 864 to transmit TB #2 via UE #2 856 to the gNB 870. As both HARQ entity #1, HARQ process #1 and HARQ entity #2 HARQ process #1 are used to transmit the same TB, i.e., TB #1 in this example, the gNB 870 could combine them together to improve the reception performance. Such combination could be either soft-combined (combining the soft symbols in HARQ #1 buffers configured at gNB for UE #1 and UE #2 respectively to store/decode the received TB) or hard-combined (combined by HARQ functions in MAC entity, e.g., after either of UE #1 and UE #2 decodes the TB successfully and passes the result on to the HARQ entity) as indicated in dashed circle 872 at the gNB 870. Different RV of the same TB could be transmitted via different HARQ processes supported by different HARQ entities. To support this, a certain relation between different HARQ processes managed by different HARQ entities is established. For example, HARQ process with the same HARQ process indices under different HARQ entities could be pre-defined/pre-configured to transmit the same TB. For example, HARQ process #1 of HARQ entity #1 and HARQ process #1 of HARQ entity #2 could be pre-defined/pre-configured to transmit the same TB. In some embodiments, such a relation between different HARQ processes of different HARQ entities is configured, for example, using higher layer signaling such as RRC or indicated by dynamic signaling such as DCI. Alternatively, it could be realized by dynamic scheduling by the gNB, which is a gNB-centric implementation and could be transparent to the UE(s). For example, the gNB could schedule the (re-) transmission of the same HARQ process via different UE(s) to the gNB and at the gNB, conduct combining of corresponding received data from different UE(s). Again, the association between the HARQ entity/HARQ process and the physical shared channels such as PUSCH of the UE(s) where the corresponding data (managed by the HARQ entity/HARQ process) could be transmitted may be configurable.

Alternatively, for UL UC transmission, in some embodiments, two or more HARQ entities are configured in the common MAC entity. One or more HARQ entities are configured to support joint (or split) HARQ processes only managing transmission/reception of the same TB across a number of UE(s). Other HARQ entities are configured to support individual HARQ processes managing transmission/reception of a TB over only one of the UE(s), Different HARQ entities could be configured to be associated with different UE(s). For example, HARQ entity #1 could be configured to only support a number of joint (split) HARQ processes across of UE #1 and UE #2, while HARQ entity #2 is configured to support a number of individual HARQ processes over UE #1, and HARQ entity #3 is configured to support a number of individual HARQ processes over UE #2. The configuration could include the association between HARQ entity/HARQ process and physical shared channels of one or more UE(s) or simply one or more UE(s) where reception of data under corresponding HARQ process occur.

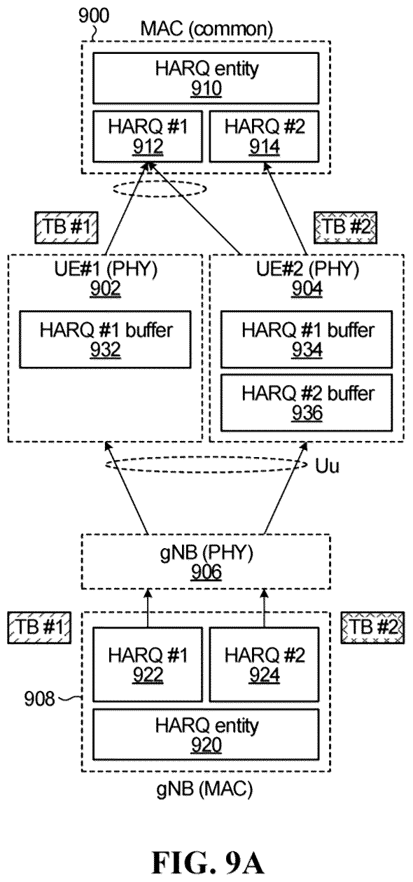

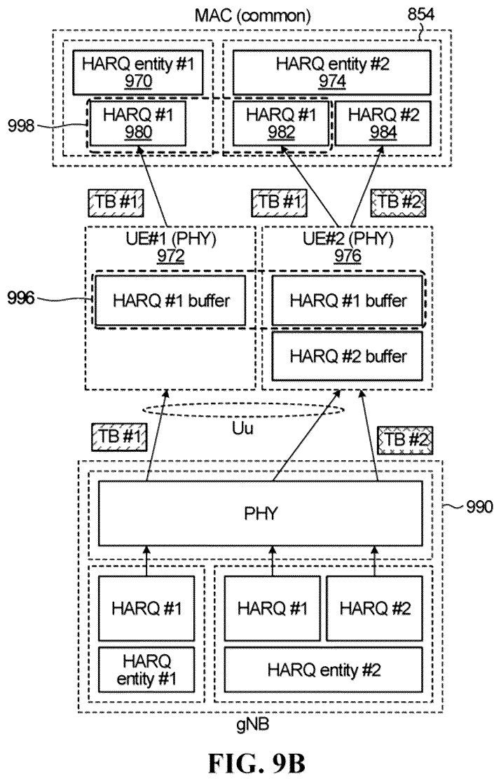

While the detailed description above has focused on uplink transmission, such embodiments are also adaptable for downlink transmission. Referring now to FIG. 9A, details of a common MAC/HARQ structure and procedure for DL UC MIMO transmission will now be described. Shown is a common MAC entity 900, two UE PHY layer 902,904 and a gNB PHY layer 906 and gNB MAC entity 908. The common MAC entity 900 could be configured in one of the UE 902,904 or in another location, such as another UE. The connections between the common MAC entity 900 and individual UE PHY layer could be wireless or wireline connection, and could be either standardized (e.g., 3GPP, IEEE) or non-standardized. The common MAC entity 900 has a common HARQ entity 910 configured that manages a number of HARQ processes. The number of HARQ processes managed by the common HARQ entity 910 could be configurable. FIG. 9A shows two HARQ processes 912,914. In the gNB MAC entity 908, there is a corresponding HARQ entity 920; HARQ processes 922,924 are shown in the gNB.

Joint HARQ processes are supported with the illustrated framework. DL data (e.g., TB) (re-) transmission for a given HARQ process can be scheduled for different UE(s). The same or different RV of the same TB can be scheduled for different UE(s). For example, as shown in FIG. 9A, transmission or retransmission of TB #1 under HARQ process #1 is scheduled for UE #1 and UE #2 respectively. RV #0 of TB #1 could be scheduled from UE #1 and RV #2 could be scheduled from UE #2. Shown is a respective HARQ #1 buffer 932,934 in each UE that are used to store/decode the received data under HARQ process HARQ #1 912. Alternatively, the TB #1 with the same RV version could be broadcast (group-cast) to multiple UE(s) (e.g., UE #1 and UE #2). Similar to uplink UC MIMO, for DL UC MIMO, the joint HARQ process (or split HARQ process) could be configured to associate with different physical shared channels operating on different UEs, for example, the physical uplink shared channel (PDSCH) for downlink. For example, joint HARQ process #1 could be configured to associate with PDSCH channels configured on UE #1 and UE #2 respectively. With such an association configured, both UE(s) and gNB could know that TB(s) managed under a certain HARQ process could be received using corresponding physical shared channels such as PDSCH via corresponding UE(s) participating in UC MIMO.

Individual HARQ processes (similar to conventional HARQ process) are also supported: in this case DL data (e.g., TB) (re-) transmission for a given HARQ process is only scheduled to one UE. An example is shown in FIG. 9A, with transmission (or retransmission) of TB #2 scheduled to UE #2 only. In this case, only UE #2 has a HARQ #2 buffer 936 that is used to store/decode received data under HARQ process HARQ #2 914. In this case, the association between the HARQ process and physical shared channel such as PDSCH on PHY layer of that particular UE is configurable. For example, HARQ process #2 can be configured to be associated with physical shared channels of UE #2.

Either or both of joint HARQ processes and individual HARQ processes could be configured for UC. For a joint HARQ process, the data received under the same HARQ process by different UE(s) could be combined to improve the reception capability. Such combination could be achieved in PHY layer (soft-symbols are passed between UE(s) via PHY layer inter-UE connection for soft combining); or achieved in the common MAC entity by hard combining (e.g., either UE(s) reports a success after decoding the packet is considered as a success for decoding the packet at MAC entity).

In the examples described so far, one end of the link features multiple UE operating in a UC manner while the other end is the network (gNB or base station). In another embodiment, the other end is one or another group of UE (to replace gNB), and a flexible framework similar to that described can be applied in this embodiment. That embodiment is more for UE MIMO transmission for UE-to-UE communication.

The common MAC entity could be configured by the gNB or by a primary UE within in a group of UE(s) formed for UC operation. The common MAC for DL/UL UC operation could be configured separately, e.g., it could be configured for DL only or for UL only or for both DL/UL.

Alternatively, for DL UC transmission, two or more HARQ entities could be configured in the common MAC entity, one for each UE involved in UC transmission. An example is shown in FIG. 9B. In this example,

For example, HARQ entity #1 970 is configured for UE #1 972 and HARQ entity #2 974 is configured for UE #2 976. For HARQ entity #1 970, it supports HARQ process #1 980 to receive TB #1 from gNB 990 to UE #1 972. For HARQ entity #2 974, it supports HARQ process #1 982 to receive TB #1 from gNB 990 to UE #2 976. It also supports HARQ process #2 984 to receive TB #2 from gNB 990 to UE #2 976. Alternatively, only HARQ entity #1 and HARQ process #1 could be used to broadcast TB #1 to both UE #1 and UE #2 respectively. As both HARQ entity #1, HARQ process #1 and HARQ entity #2 HARQ process #1 are used to receive the same TB, i.e., TB #1 in this example, they could be combined at the UE(s) to improve the reception performance. Such combination could be either soft-combined (combining the soft symbols in HARQ buffers in UE #1 and UE #2 respectively to decode the TB as indicated by dashed circle 996) or hard-combined (combined by HARQ functions in common MAC, e.g., considered as a success after either of UE #1 and UE #2 decode the TB successfully as indicated by dashed circle 998). Different RV of the same TB could be transmitted via different HARQ process supported by different HARQ entities. To support this, certain relation between different HARQ processes managed by different HARQ entities shall be established. For example, HARQ process with the same HARQ process indices under different HARQ entities could be pre-defined/pre-configured to transmit the same TB. For example, HARQ process #1 of HARQ entity #1 and HARQ process #1 of HARQ entity #2 could be pre-defined/pre-configured to receive the same TB. Such a relation between different HARQ processes of different HARQ entities to transmit the same TB could be configured for the UE(s) and thus the UE(s) could combine the same TB properly (for example when TB(s) are with different RV). The configuration could be signaled using higher layer signaling such as RRC or indicated by dynamic signaling such as DCI. Again the association between the HARQ entity/HARQ process and the physical shared channels such as PDSCH of the UE(s) where the corresponding data (managed by the HARQ entity/HARQ process) could be received may be configurable.

Alternatively, for DL UC transmission, in some embodiments, two or more HARQ entities are configured in the common MAC entity. One or more HARQ entities are configured to support joint (or split) HARQ processes only managing reception of the same TB across a number of UE(s). Other HARQ entities are configured to support individual HARQ processes managing reception of a TB from only one of the UE(s), Different HARQ entities could be configured to be associated with different UE(s). For example, HARQ entity #1 could be configured to only support a number of joint (split) HARQ processes across of UE #1 and UE #2, while HARQ entity #2 is configured to support a number of individual HARQ processes over UE #1, and HARQ entity #3 is configured to support a number of individual HARQ processes over UE #2. The configuration could include the association between HARQ entity/HARQ process and physical shared channels of one or more UE(s) where reception of data under corresponding HARQ process occur.

### Common DCI Design for UC MIMO

For scheduling UC MIMO transmission, in some embodiments, a first DCI is transmitted containing information for the SUE and another DCI is transmitted that contains information for the CUE; each DCI is a single UE DCI. In other embodiments, one common (group) DCI is transmitted that contains scheduling information for both the SUE and the CUE. In some embodiments, whether separate DCI or common DCI is used is configurable. In some embodiments, there is an indication in a DCI to indicate if it is a common DCI or not; without this indication, the DCI is a single UE DCI. In another embodiment, closed-loop MIMO uses separate DCI, while open-loop MIMO uses a common DCI.

The following is a specific example of scheduling information for transmission of two TBs for close-loop MIMO, where for separate DCI, each DCI contains one set of scheduling information, and for a common DCI each DCI contains one or two set of scheduling information, one set for (or shared by) each SUE/CUE:
one or two sets of resource allocation for PUSCH (one for each SUE/CUE);
one or two HARQ process ID and one/two RV indices (one for each SUE/CUE);
one or two sets of MCS (one for each SUE/CUE);
for CB, two sets of precoding information (one for each SUE/CUE);
for NCB, two SRS resource indications (SRS) (one for each SUE/CUE); and
one or two sets of TPC (one for each SUE/CUE).

The following is a specific example of scheduling information for one TB for open-loop MIMO, where for separate DCI, each DCI contains one set of scheduling information, and for common DCI each DCI contains one or two sets of scheduling information, one set for (or shared by) reach SUE/CUE:
one or two sets of resource allocation for PUSCH (one for each SUE/CUE);
one HARQ process ID and one/two RV indices (one for each SUE/CUE);
one or two sets of MCS (one for each SUE/CUE); and
one or two TPC (one for each SUE/CUE).

In some embodiments, where a common DCI is employed, the common DCI is transmitted in search space (SS) of both the SUE/CUE. In this case, the common DCI is transmitted twice with the same contents. In another embodiment, the common DCI is transmitted in the SS of only the SUE, and the SUE conveys the scheduling information to the CUE via inter-UE connection.

In some embodiments, common or separate DCI can be employed, and a UE determines which is being used based on an indication in the DCI. In another embodiment, the UE determines between common and separate DCI based on the size of DCI. The common DCI will have a size that is larger than that of the single UE DCI.

The provided configurable framework for UC MIMO may provide one or more of the following benefits:
open-loop MIMO and closed-loop MIMO including separate precoding and joint precoding;
protocol structure with a common MAC entity and common/separate HARQ entity;
different types of HARQ processes are supported, including joint HARQ processes and individual HARQ processes;
the ability to switch between open-loop MIMO and closed-loop MIMO or other configurations, based on explicit or implicit signaling.

Numerous modifications and variations of the present disclosure are possible in light of the above teachings. It is therefore to be understood that within the scope of the appended claims, the disclosure may be practiced otherwise than as specifically described herein.

What is claimed is:

1. A method comprising:
receiving, by a first apparatus, configuration of a common medium access control (MAC) entity;
transmitting, based on the configuration, a first transport block (TB) of data to a network device as part of a cooperative transmission, wherein the cooperative transmission is performed by a plurality of apparatuses including of the first apparatus; and
communicating a second TB of data to another apparatus of the plurality of apparatuses for transmission to the network device by the another apparatus as part of the cooperative transmission.

2. The method of claim 1, wherein the common MAC entity comprises a common hybrid automatic repeat request (HARQ) entity or a plurality of HARQ entities.

3. The method of claim 1 wherein the common MAC entity comprises a common HARQ entity configured with one or more HARQ processes, each of which is associated with one or more of the plurality of apparatuses.

4. The method of claim 1, wherein:
the first TB of data and the second TB of data involve a same TB of data; and
the common MAC entity comprises a common HARQ entity, and wherein the common HARQ entity is configured with a HARQ process for managing the transmission of the same TB of data by the first apparatus and the another apparatus.

5. The method of claim 1, wherein:
the first TB of data and the second TB of data involve a same TB of data; and
the common MAC entity comprises a first HARQ entity that is configured with a first HARQ process for managing the transmission of the first TB of data to the network device and a second HARQ entity that is configured with a second HARQ process for managing the transmission of the same TB of data by the another apparatus.

6. The method of claim 1, wherein the common MAC entity comprises a first HARQ entity that is configured with a first HARQ process for managing transmission of the first TB of data by the first apparatus and a second HARQ entity that is configured with a second HARQ process for managing transmission of the second TB of data by the another apparatus.

7. The method of claim 1, wherein the common MAC entity comprises a first HARQ entity in respect of TB transmission by the first apparatus and another HARQ entity in respect of TB transmission by the another apparatus of the plurality of apparatuses, and wherein:
in a case of duplicate TB transmission, the first HARQ entity is configured with a first HARQ process in respect managing the transmission of the first TB of data to the network device by the first apparatus and the another HARQ entity is configured with another HARQ process in respect of managing duplicate transmission of the same TB of data by the another apparatus, wherein the first TB of data and the second TB of data are the same TB of data; and
in a case of split TB transmission, the first HARQ entity is configured with a first HARQ process in respect of the first TB of data to the network device by the first apparatus, and the another HARQ entity is configured with a second HARQ process in respect of transmission of the second TB of data by the another apparatus.

8. A method comprising:
transmitting, by a network device to a first apparatus, a configuration of a common medium access control (MAC) entity in the first apparatus;
receiving a first transport block (TB) of data from the first apparatus as part of a cooperative transmission, wherein the cooperative transmission is performed by a plurality of apparatuses including the first apparatus; and
receiving a second TB of data from another apparatus of the plurality of apparatuses as part of the cooperative transmission.

9. The method of claim 8, wherein the common MAC entity comprises a common hybrid automatic repeat request (HARQ) entity or a plurality of HARQ entities.

10. The method of claim 8, wherein the common MAC entity comprises a common HARQ entity configured with one or more HARQ processes, each of which is associated with one or more of the plurality of apparatuses.

11. The method of claim 8, wherein:
the first TB of data and the second TB of data involve a same TB of data; and
the common MAC entity comprises a common HARQ entity, and wherein the first TB of data received from the first apparatus and the same TB of data received from the another apparatus are managed by the same HARQ process configured for the common HARQ entity.

12. The method of claim 8, wherein:
the first TB of data and the second TB of data involve a same TB of data; and
the common MAC entity comprises a first HARQ entity and a second HARQ entity, and wherein the first TB of data received from the first apparatus is managed by a first HARQ process configured for the first HARQ entity, and the same TB of data received from the another apparatus is managed by a second HARQ process configured for the second HARQ entity.

13. The method of claim 8, wherein the common MAC entity comprises a first HARQ entity that is configured with a first HARQ process for managing transmission of the first TB of data by the first apparatus and a second HARQ entity that is configured with a second HARQ process for managing transmission of the second TB of data by the another apparatus.

14. An apparatus comprising:
at least one processor coupled with a non-transitory computer readable medium storing instructions, wherein when the instructions are executed by the at least one processor, the apparatus is caused to perform operations comprising:
receiving configuration of a common medium access control (MAC) entity;
transmitting a first transport block (TB) of data to a network device as part of a cooperative transmission, wherein the cooperative transmission is performed by a plurality of apparatuses inclusive of the apparatus; and
communicating a second TB of data to another apparatus of the plurality of apparatuses for transmission to the network device by the another apparatus as part of the cooperative transmission.

15. The apparatus of claim 14 wherein the common MAC entity comprises a common HARQ entity or a plurality of HARQ entities.

16. The apparatus of claim 14 wherein the common MAC entity comprises a common HARQ entity configured with one or more HARQ processes each of which is associated with one or more of the plurality of apparatuses.

17. The apparatus of claim 14, wherein:
the first TB of data and the second TB of data involve a same TB of data; and
the common MAC entity comprises a common HARQ entity, and wherein the common HARQ entity is configured with a HARQ process for managing the transmission of the same TB of data by the apparatus and the another apparatus.

18. The apparatus of claim 14, wherein:
the first TB of data and the second TB of data involve a same TB of data; and
the common MAC entity comprises a first HARQ entity that is configured with a first HARQ process for managing the transmission of the first TB of data to a network device and a second HARQ entity that is configured with a second HARQ process for managing the transmission of the same TB of data by the another apparatus.

19. The apparatus of claim 14, wherein the common MAC entity comprises a first HARQ entity that is configured with a first HARQ process for managing transmission of the first TB of data by the apparatus and a second HARQ entity that is configured with a second HARQ process for managing transmission of the second TB of data by the another apparatus.

20. The apparatus of claim 14, wherein the common MAC entity comprises a first HARQ entity in respect of TB transmission by the apparatus and another HARQ entity in respect of TB transmission by the another apparatus of the plurality of apparatuses, and wherein:
in a case of duplicate TB transmission, the first HARQ entity is configured with a first HARQ process in respect managing the transmission of the first TB of data to the network device by the apparatus and the another HARQ entity is configured with another HARQ process in respect of managing duplicate transmission of the same TB of data by the another apparatus,
wherein the first TB of data and the second TB of data are the same TB of data; and in a case of split TB transmission, the first HARQ entity is configured with a first HARQ process in respect of the first TB of data to the network device by the apparatus, and the another HARQ entity is configured with a second HARQ process in respect of transmission of the second TB of data by the another apparatus.
